(19) United States
(12) Patent Application Publication
(10) Pub. No.: US 2005/0127626 A1
(43) Pub. Date: Jun. 16, 2005

(54) Wheelbarrow or the like with a body of synthetic material

(75) Inventors: Bernard Haemmerlin, Strasbourg (FR); Dominique Lotz, Dettwiller (FR)

Correspondence Address: YOUNG & THOMPSON, 745 SOUTH 23RD STREET, 2ND FLOOR, ARLINGTON, VA, 22202, US

(73) Assignee: HAEMMERLIN SAS (SOCIETE PAR ACTIONS SIMPLIFIEE), MONSWILLER (FR)

(21) Appl. No.: 11/009,050

(22) Filed: Dec. 13, 2004

(30) Foreign Application Priority Data
Dec. 12, 2003 (FR) 0314634

(51) Int. Cl. B62B 1/18

(52) U.S. Cl. 280/47.31

(57) ABSTRACT

A wheelbarrow constituted by a body (1) mounted on an assembly of handlebars (2)-feet (3)-wheel bearings (4) and a wheel (5), wherein the body (1) is of synthetic material and has an upper turned over edge (1′) and is moreover provided with at least one device (1″) for supporting and holding tools, as well as a removable double bottom (6) matching the internal contours of the body (1) at a certain distance from the bottom of this latter.

The present invention relates to the field of handling devices, and more particularly wheelbarrows, and has for its object a wheelbarrow or the like with a body of synthetic material.

Wheelbarrows for workplaces or the yard that are known at present are generally made in the form of an assembly of a body, handlebars, a foot and wheel-bearing assembly, and a wheel.

The body of present wheelbarrows is most often made of stamped sheet metal and fixed on the infrastructure by bolting. Such a sheet metal body generally has a long lifetime, as well as good rigidity, such that the wheelbarrows thus made are very reliable and resistant.

However, the production of sheet metal bodies has the drawback of rendering these wheelbarrows relatively noisy in use and, due to the fact of their production from metal, they are of relatively heavy weight, rendering their use cumbersome for small jobs, in particular gardening and maintenance.

To overcome these drawbacks, it has been proposed to use a body of synthetic material, also fixed on the infrastructure by bolting. Such a body permits substantially lightening the wheelbarrows thus equipped and rendering their use, in particular for light work, more acceptable. However, the bodies of synthetic material used at present have the drawback of being relatively fragile and not very rigid, such that their lack of reliability greatly impedes their widespread use, particularly for leisure gardening.

Finally, the existing wheelbarrow bodies, whether in synthetic material or metal, are not generally adapted to fulfill supplemental functions, of storage and/or temporary support of objects or else for the provision of compartments adapted for particular uses.

The present invention has for its object to overcome these drawbacks by providing a wheelbarrow or the like with a synthetic material body permitting fulfilling different functions, whilst having rigidity comparable to those of sheet metal bodies.

To this end, the wheelbarrow is characterized in that the body is of synthetic material, has a turned over edge and is moreover provided with at least one device for supporting handling tools, as well as a removable double bottom matching the internal contours of the body at a certain distance from the bottom of this latter.

The invention will be better understood from the following description, which relates to a preferred embodiment, given by way of non-limiting example, and explained with reference to the accompanying schematic drawings, in which:

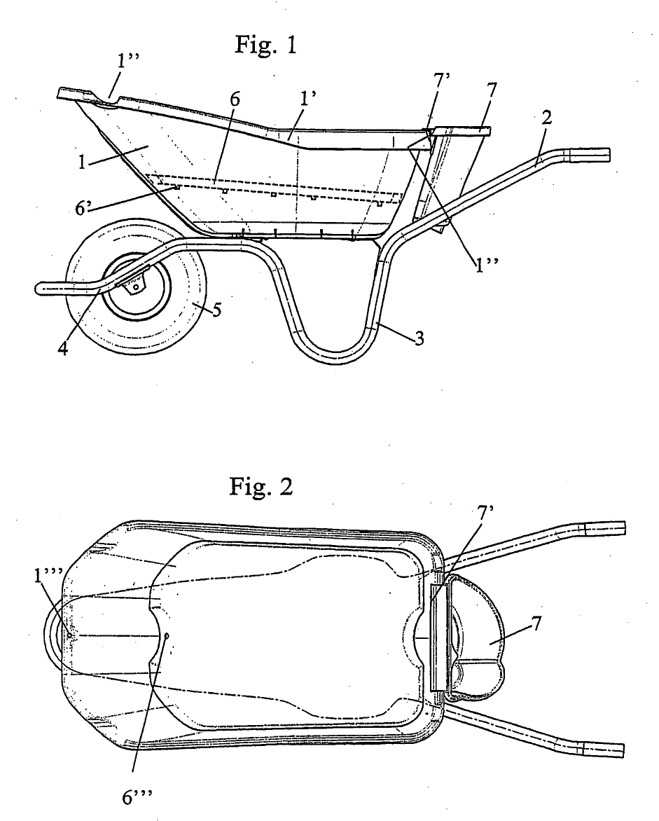

FIG. 1 is a side elevational view of a wheelbarrow according to the invention;

FIG. 2 is a top plan view according to FIG. 1;

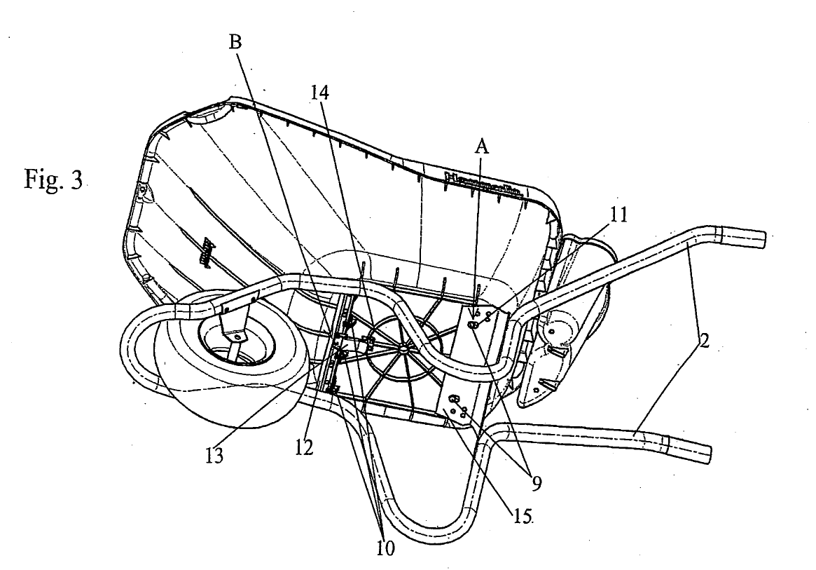

FIG. 3 is a perspective view from below of the wheelbarrow of FIG. 1;

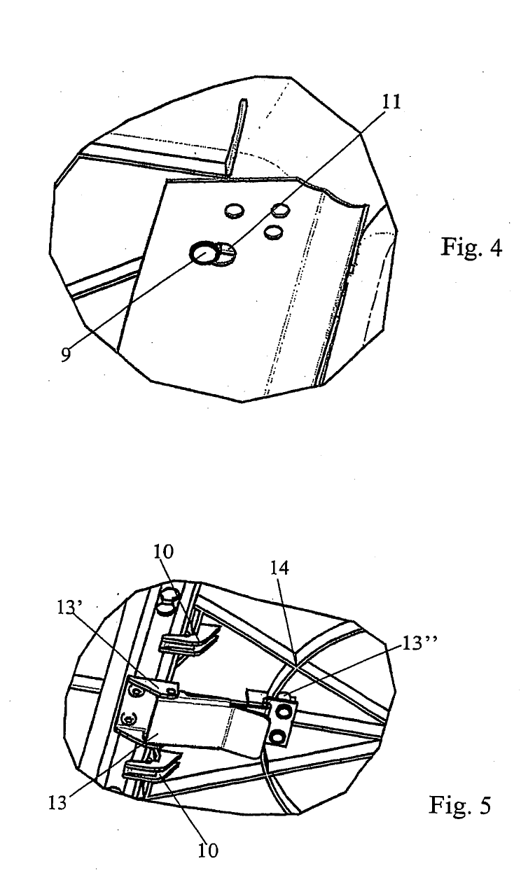

FIGS. 4 and 5 are fragmentary perspective views, on a larger scale, of details A and B of FIG. 3, and

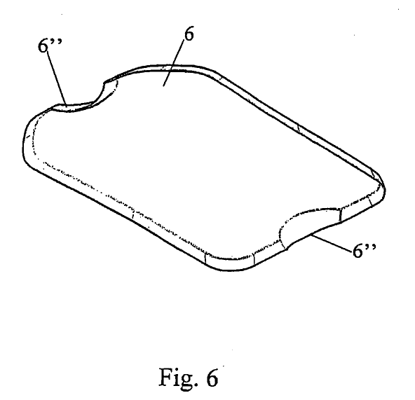

FIG. 6 is a perspective view of the double bottom.

FIGS. 1 to 3 of the accompanying drawings show a wheelbarrow constituted by a body 1 mounted on an assembly of handlebars 2-feet 3-wheel bearings 4, and by a wheel 5.

According to the invention, the body 1 is of synthetic material, has a turned over edge 1′ and is provided moreover with at least one device 1″ for supporting and holding tools, as well as a removable double bottom 6 matching the internal contours of the body 1 at a certain distance from the body of this latter. The turnover 1′ of the edge of the body 1 permits improving the rigidity of this edge and thus prevents deformation of the body 1 under a load, in particular at its periphery.

According to one characteristic of the invention, the body 1 has a substantial height relative to its loaded volume. Such a construction of a high body permits further improving the rigidity of said body and prevents in particular its deformation near the upper edge by distribution of the forces over a larger height of the wall.

According to another characteristic of the invention, the edge of the body 1 can preferably be provided with a peripheral reinforcement in the form of a hollow channel molded by gas injection.

Such a hollow peripheral channel permits improving substantially the rigidity of the edge of the body 1.

The removable double body 6 matching the internal contours of the body 1 is preferably also made of rigid synthetic material and is moreover provided with a reinforcing and rigidification framework 6′ on its surface turned toward the bottom of the body 1 (FIG. 1). This removable double bottom 6 is moreover provided on its two opposite sides with gripping openings 6″ (FIGS. 2 and 6). These latter are adapted to permit the passage of a hand to grasp said removable double bottom 6 for taking it out of the body 1, as well as for its replacement in said body 1.

This removable double bottom 6 permits for example having in the bottom of the body 1 certain materials and covering them during transport with the removable double bottom 6, which can thus serve to support small tools or other materials. Thus, for example, for gardening work, it is possible to arrange in the bottom of the body 1 compost and/or soil and to place on the removable double bottom 6 small gardening tools, as well as flowerpots or the like.

The devices 1″ for the support and holding of tools are preferably provided in the transverse edges of the body 1, near the ends of the connection with the longitudinal edges (FIGS. 1 and 2) and are present in the form of recesses provided in said edges. These devices 1″ in the form of recesses permit particularly to receive the handles of long-handled tools, such as shovels, spades, rakes, etc. . . . Thus, these tools, which are generally difficult to hold in a wheelbarrow without causing trouble to the user, are perfectly disposed and held on the body 1, whilst leaving entirely available the volume of this latter and without giving rise to trouble for the user during transport.

The double bottom 6, which is mounted removably in the body 1, can serve, after its removal from this latter and arrangement crosswise on the body 1, as a working surface, for example, for operations of repotting or the like.

According to another characteristic of the invention, and as shown in FIGS. 1 to 3 of the accompanying drawings, the body 1 can be provided moreover with one or several removable tool pots provided with fastening means such as hooks or a corner flange co-acting with the upper edge of the body 1. Such a tool pot 7 can be disposed preferably, as shown in FIGS. 1 and 3, on the rear edge of the body 1, but could also be mounted on the sides of said body 1. This pot 7 can be provided preferably for the reception of small gardening tools or the like, but can also serve if desired for the reception of materials such as fertilizer or the like.

According to another characteristic of the invention, and as shown more particularly in FIGS. 3 to 5 of the accompanying drawings, the body 1 is preferably mounted on the assembly of handlebars 2-feet 3-wheel bearings 4 and wheel 5 in a removable manner, by means of a rapid securement device 8 essentially constituted by waisted pins 9 and hooks 10 provided below the bottom of the body 1 and co-acting respectively with eyelets 11 and a crosspiece 12 of said assembly of handlebars 2-feet 3-wheel bearings 4 and wheel 5, and by a resilient locking means 13 provided on the crosspiece 12 and co-acting with a rib 13 on the lower surface of the bottom of the body 1. The eyelets 11 co-acting with waisted pins 9 are made in a sheet metal crosspiece 15 connecting the handlebars 2 (FIG. 3).

FIG. 4 of the accompanying drawings, which is a representation on a large scale of detail A of FIG. 3, shows the co-action between the eyelet 11 and a waisted pin 9, whilst FIG. 5 shows, in detail B, the co-action between the hooks 10 and the crosspiece 12, as well as the resilient locking means 13 co-acting with a rib 14 extending below the bottom of the body 1. This locking means can, as shown in FIG. 5, be present in the form of a resilient tongue which is spring loaded, mounted on the crosspiece 12 by means of a bearing 13′ and provided at its opposite end with hooks or tenons 13″ adapted to fasten behind the rib 14 in the locking position of the body 1.

Thus, the body 1 can be simply mounted on its support and rolling assembly by arrangement above the crosspieces 12 and 15 with the insertion of pins 9 in the eyelets 11 and arrangement of the hooks 10 before the crosspiece 12. Then, a movement of the body rearwardly of the wheelbarrow (in the direction of the wheel 5) will have the effect of engaging the pins 9 with the narrowed portion of the eyelets 11 by means of their waist, whilst the hooks 10 engage below the crosspiece 12. At the end of the locking path, the end of the resilient locking means 13 engages by its hooks or pins 13″ behind the rib 14 provided below the bottom of the body 1 and thus lock this latter in position. For disassembly of the body 1, it suffices simply to pull on the tongue forming the means 13 to disengage the pins or hooks 13″ from their engagement with the rib 14 to be able to carry out the reverse movement of the body 1, permitting its disassembly from the assembly of handlebars 2-feet 3-wheel bearings 4 and wheel 5.

This mode of securement of the body 1 on the assembly of handlebars 2-feet 3-wheel bearings 4 and wheel 5 permits avoiding the provision of securement holes in said body 1, such that this latter is perfectly liquid tight. Moreover, the removability of the body 1 permits, for transportation and storage, a stacking of a large number of bodies in a reduced volume, which gives rise to corresponding reduction of costs.

According to another characteristic of the invention, the body 1 and the removable double bottom 6 are preferably provided on their front edge with a hole 1′″ respectively 6′″ permitting their hanging up on a wall. Such a wall hanging of the double bottom 6 and of the assembly of the wheelbarrow by means of its body 1 permits a substantial saving of space for the user during periods of non-use of the wheelbarrow.

Thanks to the invention, it is possible to provide a wheelbarrow or the like which is disassembleable, having a body of synthetic material with high rigidity and multifunctional. Thus, because of the provision of the double bottom, the wheelbarrow can serve several uses simultaneously. This high functionality is further improved by the provision of at least one removable tool pot permitting the storage of small accessories, even the reception of materials.

Finally, because of the provision of the device 1″ for reception and holding tools, the long-handled or semi-long-handled tools can be arranged in an optimum manner on the wheelbarrow without causing trouble for the load or the user.

Of course, the invention is not limited to the embodiment described and shown in the accompanying drawings. Modifications remain possible, particularly as to the construction of the various elements or by substitution of technical equivalents, without thereby departing from the scope of protection of the invention.

1. A wheelbarrow constituted by a body (1) mounted on an assembly of handlebars (2)-feet (3)-wheel bearings (4) and a wheel (5), wherein the body (1) is of synthetic material, and has a turned over edge (1′) and is moreover provided with at least one device (1″) for the support and holding of tools, as well as a removable double bottom (6) matching the internal contours of the body (1) at a certain distance from the bottom of this latter.

2. A wheelbarrow as claimed in claim 1, wherein the body (1) has a substantial height relative to its loading volume.

3. A wheelbarrow according to claim 1, wherein the edge of the body (1) is provided with a peripheral reinforcement in the form of a hollow channel molded by gas injection.

4. A wheelbarrow according to claim 1, wherein the removable double bottom (6) matching the internal contours of the body (1) is also made of rigid synthetic material and is moreover provided with a reinforcing and rigidifying framework (6′) on its surface turned toward the bottom of the body (1).

5. A wheelbarrow according to claim 1, wherein the removable double bottom (6) is moreover provided on two opposite sides with gripping openings (6′).

6. A wheelbarrow according to claim 1, wherein the devices (1″) for support and holding of tools are provided in the transverse edges of the body (1), near the ends of connection with the longitudinal edges and are present in the form of recesses provided in said edges.

7. A wheelbarrow according to claim 1, wherein the body (1) is provided moreover with at least one removable tool pot (7) provided with attachment means (7′) in the form of hooks or a corner flange co-acting with the upper edge of the body (1).

8. A wheelbarrow according to claim 1, wherein the body (1) is mounted on the assembly of handlebars (2)-feet (3)-wheel bearings (4) and wheel (5) removably, by means of a quick securement device (8) constituted by waisted pins (9) and hooks (10) provided on the bottom of the body (1) and co-acting respectively with eyelets (11) and a crosspiece (12) of said assembly of handlebars (2)-feet (3)-wheel bearings (4) and wheel (5) and by resilient locking means (13) provided on the crosspiece (12) and co-acting with a rib (14) on the lower surface of the bottom of the body (1).

9. A wheelbarrow according to claim 8, wherein the eyelets (11) co-acting with the waisted pins (9) are made in a sheet metal crosspiece (15) connecting the handlebars (2).

10. A wheelbarrow according to claim 8, wherein the locking means (13) is present in the form of a spring loaded resilient tongue, mounted on the crosspiece (12) by means of a bearing (13′) and provided at its opposite end with hooks or pins (13′) adapted to fasten behind the rib (14) in the locking position of the body (1).

11. A wheelbarrow according to claim 1, wherein the body (1) and the removable double bottom (6) are provided on each of their forward edges with a respective hole (1′″ and 6′″) permitting their hanging on a wall.
